(19) United States
(12) Patent Application Publication
(10) Pub. No.: US 2022/0026026 A1
(43) Pub. Date: Jan. 27, 2022

(54) SELF-CONTAINED PORTABLE DEVICE FOR FILLING CYLINDERS WITH HIGH-PRESSURE HYDROGEN

(71) Applicant: "BMBX" LLC, Moscow (RU)

(72) Inventors: Aleksandr Dmitrievich IVANOV, Moscow (RU); Mariia Andreevna KLIMOVA, Moscow (RU); Olga Vladimirovna NETSKINA, Novosibirsk (RU); Sergey Ivanovich NEFEDKIN, Moscow (RU); Sergei Vladimirovich PANOV, Rybinsk (RU); Mikhail Yurievich CHAIKA, Voronezh (RU); Sergei Viktorovich SHUBENKOV, Moscow (RU); Aleksei Viktorovich IVANENKO, Zvenigorod (RU)

(21) Appl. No.: 17/312,633

(22) PCT Filed: Dec. 6, 2019
(86) PCT No.: PCT/RU2019/050238

§ 371 Date: Jun. 10, 2021

(30) Foreign Application Priority Data
Dec. 14, 2018 (RU) 2018144414

(51) Int. Cl. F17C 5/06; C01B 3/06; F17C 11/00

(52) U.S. Cl. CPC F17C 5/06; C01B 3/06; F17C 11/005; F17C 2227/0341; F17C 2221/012; F17C 2227/041; F17C 2250/0642; F17C 2265/025; F17C 2227/0135

(57) ABSTRACT

The invention relates to power engineering equipment, in particular, to an self-contained portable device for filling cylinders with high-pressure hydrogen at preliminary high-pressure hydrogen production from hydrolysis. The technical result of the invention is providing with high-purity high-pressure hydrogen charging in any place, where there is an access to water, with complete elimination of power costs, reducing reactor weight, high performance reliability and easy servicing of the device. The self-contained portable device for charging cylinders with high-pressure hydrogen comprising a reaction chamber containing a solid reagent cartridge and reaction liquid pipe configured to supply liquid reagent to the lower part of the reaction chamber, a refrigerant dryer comprising installed in series a hydrogen cooler, filter-separator and hydrogen dryer, liquid reagent pipeline connected with the reaction liquid pipe, high-pressure hand pump connected with the liquid reagent pipeline to the reaction chamber and configured to feed liquid reagent in portions to the reaction chamber, gaseous hydrogen pipeline connecting the reaction chamber and refrigerant dryer, treated gaseous hydrogen pipeline configured to supply high-pressure hydrogen from the refrigerant dryer to a cylinder, wherein the gaseous hydrogen pipeline, treated gaseous hydrogen pipeline and liquid reagent pipeline are equipped with quick-release couplings, and the reaction chamber is placed in the reaction chamber cooling tank.

### FIELD OF THE INVENTION

The invention relates to power engineering equipment, in particular, to a self-contained portable device for charging cylinders with high-pressure hydrogen at preliminary high-pressure hydrogen production from hydrolysis.

### BACKGROUND

The prior art U.S. Pat. No. 7,078,012 B2, publ. on 18 Jul. 2006, discloses a device for high-pressure hydrogen production comprising a reaction chamber, liquid (water or at least one catalyst solution) storage vessel, reagent (metal or metal hydride solution) storage vessel, hydrogen dryer and hydrogen storage vessel, wherein, liquid from the liquid storage vessel is pumped through a pipeline to the reaction chamber, reagent from the reagent storage vessel is supplied through a pipeline to the reaction chamber, and hydrogen produced in the reaction chamber is supplied in a gas pipeline through a hydrogen dryer to the hydrogen storage vessel.

The disadvantages of the above device are as follows:

The device design is complicated by availability of several chambers, including fuel, catalytic and spent fuel chambers, that increases the system weight and dimensions.

Gas line using N₂ does not allow for portable design.

Pressure of hydrogen produced from the reaction is significantly below than pressure in the claimed device, that does not allow to charge the composite cylinders with the produced hydrogen up to 350 bar.

The device does not meet the conditions of portable charging, which could be used for cylinder charging during flights, since hydrogen production rate is too slow and is 1.5 l/min. Therefore, 33 hours is required to charge 10 l cylinder (about 3 m³).

Use of electrical pump that presupposes connecting to electric power network, i.e. does not allow to use the device autonomously.

Also the prior art U.S. Pat. No. 7,316,718 B2, publ. on 8 Jan. 2008 discloses a hydrogen production device comprising a catalytic chamber with a catalyst, fuel chamber with reagent hydrogen-containing material (borohydride) connected with the catalytic chamber, spent fuel chamber connected with the catalytic chamber configured to store hydrogen and borate separately, gas pipeline with a check valve connected with the fuel chamber and spent fuel chamber, gaseous hydrogen discharge pipeline.

The disadvantages of the above device are as follows:

The device is not portable due to availability of several interconnected vessels (liquid tank, second liquid source, force pump, reagent tank, mixture feed unit, hydrogen storage vessel, hydrogen drying vessel), that makes the design complicated, heavy and massive.

Use of the force pump to maintain pressure in the system is also a disadvantage of the system: impossibility of using the pump without electricity makes the device not autonomous.

Considerable weight of the device due to necessity to use excess amount of water. Besides, catalyst is stored in a separate container, and liquid carrier (water) is required for catalyst mixing.

The prior art RU 2183302 C2, publ. on 10 Jun. 2002, discloses a device for high-pressure hydrogen cylinder charging. The high-pressure hydrogen cylinder charging device comprises a hydrogen generator with a hydrogen filling vessel, which provides for hydrogen cylinder charging through a hose with a bayonet connector.

The disadvantages of the above known device are as follows:

1. It is not autonomous, i.e it cannot operate without connection to a power source.

2. It is not portable, i.e. has considerable dimensions and weight, apart from weight and dimensions of the additional equipment required for cylinder immersion to a depth.

3. It can be used on a ship in voyage.

4. It does not charge the cylinders with hydrogen over 150 atm.

Besides, the prior art RU 2455394 C1, publ. on 10 Jul. 2012, prototype, discloses a device for high-pressure hydrogen cylinder charging. The high-pressure hydrogen cylinder charging device comprises a hydrogen generator and cylinders pneumatically connected with the hydrogen generator.

The disadvantages of the above disclosed device are as follows:

1. It is not autonomous, i.e. it cannot operate without connection to a power source.

2. It is not portable, i.e. has considerable dimensions and weight, including weight and dimensions of the additional equipment required for water treatment.

### SUMMARY OF THE INVENTION

The object of the claimed invention is development of the self-contained portable device for charging cylinders with high-pressure hydrogen, which combines a hydrogen generator and device for charging cylinders high-pressure hydrogen.

The technical result of the invention is providing with high-purity high-pressure hydrogen charging in any place, where there is an access to water, with complete elimination of power costs, small weight of the reactor enabling to relocate it, high performance reliability and easy servicing of the device.

The stated technical result is achieved due to the fact that the self-contained portable device for self-contained high-pressure hydrogen comprises a reaction chamber containing a solid reagent cartridge and reaction liquid pipe configured to supply the reaction liquid to the lower part of the reaction chamber, a refrigerant dryer comprising installed in series a hydrogen cooler, filter-separator and hydrogen dryer, liquid reagent (water possibly containing impurities) pipeline connected with the reaction liquid pipe, high-pressure hand pump connected with the liquid reagent pipeline to the reaction chamber and configured to feed liquid reagent in portions to the reaction chamber, gaseous hydrogen pipeline connecting the reaction chamber and refrigerant dryer, treated gaseous hydrogen pipeline configured to supply high-pressure hydrogen from the refrigerant dryer to a cylinder, wherein the gaseous hydrogen pipeline, treated gaseous hydrogen pipeline and liquid reagent pipeline are equipped with quick-release couplings, and the reaction chamber is placed in the cooling means.

### BRIEF DESCRIPTION OF DRAWINGS

The invention will be more clear from non-limiting description with references to the attached drawings illustrating as follows:

FIG. 1—Schematic diagram of the device.

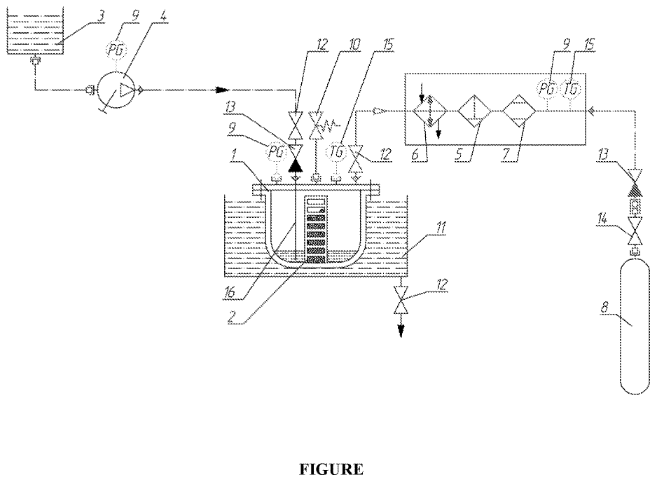

1—reaction chamber; 2—solid reagent cartridge; 3—low-pressure tank; 4—high-pressure hand pump; 5—filter-separator; 6—hydrogen cooler; 7—hydrogen dryer, 8—hydrogen cylinder; 9—pressure gage; 10—safety valve; 11—reaction chamber cooling tank; 12—ball valve; 13—check valve; 14—cylinder cutoff valve; 15—thermometer; 16—reaction liquid pipe.

### Conventions:

[symbol] —Liquid flow direction

[symbol] —Gas flow direction

[symbol] —Flexible pipeline

[symbol] —Coupling nut joint

[symbol] —Quick-release couplings

[symbol] —Male couplings

[symbol] —Female couplings

### Embodiment of the Invention

The self-contained portable device for charging cylinders high-pressure hydrogen comprises a reaction chamber (1), reaction liquid pipe (16), hydrogen cooler (6) and hydrogen dryer (7) with filter-separator (5), hand pump (4), liquid reagent pipeline, gaseous hydrogen pipeline and treated gaseous hydrogen pipeline.

The reaction chamber (1) contains solid reagent cartridge (2), and the reaction liquid pipe (16) itself is equipped with a pressure gage (9) and thermometer (15) and is located in the reaction chamber cooling tank (11). The reaction liquid pipe (16) supplies liquid reagent to the lower part of the reaction chamber (1). One end of the liquid reagent pipeline is connected with the reaction liquid pipe (16), and the other end—with the high-pressure hand pump (4) which feeds liquid reagent in portions to the reaction chamber (1), wherein, the liquid reagent pipeline are equipped with quick-release couplings and the check valve (13). High-pressure hand pump (4) is connected with the low-pressure tank (3) by means of the liquid reagent pipeline. The gaseous hydrogen pipeline connects the reaction chamber (1), the cooler (6) and the hydrogen dryer (7). The gaseous hydrogen pipeline could be located either in the reaction chamber pressure cap, or outside the cap and be connected with the reaction chamber (1), cooler (6) and dryer (7) by quick-release couplings. The treated gaseous hydrogen pipeline supplies high-pressure hydrogen from the cooler (6) and the dryer (7) to the cylinder (8), wherein, the treated gaseous hydrogen pipeline is equipped with quick-release couplings, check valve (13), pressure gage (9), thermometer (15) and cylinder cutoff valve (14).

Solid reagent could be selected from the group: NaBH₄, LiBH₄, KBH₄, Mg(BH₄)₂, Ca(BH₄)₂, NH₄BH₄, (CH₃)₄, NaAlH₄, LiAlH₄, KAlH₄, NaGaH₄, LiGaH₄ and KGaH₄, MgH₂, aluminum or its alloys with the following metals: Fe, Bi, Sn, Ga, In. Solid reagent is in the form of a powder or a tablet of compressed substance disclosed above with possible addition of 5-20% catalyst (hydrogen release rate increases in presence of 5-10% catalyst, if too high concentrations exceeding 20% are used, the reaction rate decreases due to competition between OH⁻ and BH₄⁻ anions for adsorption places on the catalyst surface).

Liquid reagent could be distilled, fresh, sea, melt water with 0-10 mg/l content of impurities (Ca²⁺, Mg²⁺, Na⁺, K⁺, I⁻, HSO₃⁻, SO₂³⁻, bicarbonates, sulphates, chlorides).

Low-pressure tank (3) for liquid reagent supply could be any means contained in the place of cylinder charging and through which liquid reagent could be supplied to the reaction chamber (1) by hand pump (4). Low-pressure tank (3) for liquid reagent supply are vessels of different volume.

Reaction chamber cooling tank (11) could be any means contained in the place of cylinder charging and enabling to cool the reaction chamber (1).

Reaction chamber cooling tank (11) is a vessel of different volume.

Water or snow is used as a cooling fluid for cooling the reaction chamber (11).

Standard materials (silica gel; silicalite; zeolites, including molecular sieves—NaA, CaA, NaX, ZSM-5, NaY and their combinations; calcium chloride; aluminum oxide; vermiculite and their combinations, for example, CaCl₂—SiO₂, CaCl₂—Al₂O₃) are used as a filter-separator.

The claimed device operates as follows. The claimed self-contained portable device for charging cylinders with high-pressure hydrogen is delivered disassembled to the place of high-pressure hydrogen cylinder charging. The disassembled self-contained portable device for charging cylinders with high-pressure hydrogen consists of the following parts: reaction chamber (1) with cartridge (2) containing solid reagent; reaction liquid pipe (16); gas treatment unit, comprising hydrogen cooler (6), filter-separator (5) and hydrogen dryer (7) installed in series; liquid reagent pipeline, gaseous hydrogen pipeline and treated gaseous hydrogen pipeline. When the self-contained portable device for self-contained with high-pressure hydrogen is delivered, the device is assembled in situ. For this purpose, the reaction chamber (1) is placed in the reaction chamber cooling tank (11)—vessel with water taken in the cylinder (9) charging place. Cartridge (2) comprising a solid reagent in the form of a powder or tablets from the above list is placed into the reaction chamber (1) with top cover removed. The cartridge is fixed on the reaction chamber (1) bottom and center, then the top cover of the reaction chamber (1) is tightly closed, and the gas treatment unit, comprising hydrogen cooler (6), filter-separator (5) and hydrogen dryer (7) installed in series, is installed on the cover, while the hydrogen cooler and dryer are connected with the gaseous hydrogen pipeline, located inside the reaction chamber (1) cover, by quick-release couplings.

Then the high-pressure hand pump (4) is connected with the reaction liquid pipe (16) through the liquid reagent pipeline by quick-release couplings. The high-pressure hand pump (4) and low-pressure tank (3) for liquid reagent supply (water vessel is filled in the place of cylinder charging) are connected through the liquid reagent pipeline by quick-release couplings. Hydrogen cooler (6), hydrogen dryer (7) and hydrogen charged cylinder (9) are connected through the treated gaseous hydrogen pipeline by quick-release couplings. When the claimed device is assembled, the first portion of liquid reagent (water) is supplied from the low-pressure tank (3) for liquid reagent supply through the liquid reagent pipeline to the reaction chamber (1) by high-pressure hand pump (4).

Volume of liquid reagent portions corresponds to the high-pressure hand pump (4) chamber volume and could be 50-1,000 ml. Hydrogen is produced in the reaction chamber (1) as a result of hydrolysis of the first portion of liquid reagent and solid reagent located below the liquid reagent level. Hydrolysis products fill up the camber free volume heightwise not above the height of the reacted solid reagent. The produced hydrogen raises up in the reaction chamber (1) and through the gaseous hydrogen pipeline enters the gas treatment unit where hydrogen is cooled and dried by means of hydrogen cooler (6), filter-separator (5) and hydrogen dryer (7) installed in series. Then, the cooled and dried hydrogen enters the cylinder (8) via the treated gaseous hydrogen pipeline through the check valve. Then the second portion of liquid reagent is supplied, and further cylinder hydrogen charging operations are carried out similar to the operations after feeding the first portion of liquid reagent. Portion feeding of liquid reagent is executed until the cylinder (8) pressure is 350 bar, which is monitored on the pressure gage (9) in the treated gaseous hydrogen pipeline, closing the isolating valve (13) in the treated gaseous hydrogen pipeline, and disconnecting the charged cylinder (8) by quick-release connections. Then, connecting the empty cylinder to the treated gaseous hydrogen pipeline (15) by quick-release couplings, opening the isolating valve (13) in the treated gaseous hydrogen pipeline (15), and beginning slow charging of empty cylinder (8) by pressure equalization. If necessary, several empty cylinders (8) are used for recharging. When operation of the claimed device is completed (all cylinders are charged or solid reagent level in the cartridge is critical), if residual hydrogen is present in the device, there is hydrogen removing from the catalytic chamber, then opening the catalytic chamber cover, removing cartridge and hydrolysis products, washing the chamber and preparing it for the next charging. Hydrolysis reaction with gaseous hydrogen production is carried out at the temperature from −40° C. (when using salt solution and acid solution instead of water) to +350° C. and pressure from 0 bar to 700 bar inside the reactor. Hydrogen parameters in the reaction chamber (1) are monitored using readings of the thermometer (15) and pressure gage (9). It is not allowed to heat the reaction chamber (1) above the upper permissible temperature, for the purpose of decreasing the temperature in the reaction chamber (1) delay time between water portions supply is reduced. In case of using as a solid reagent one of the following catalysts could be added: CoCl₂ , Co₂O₃, CoO, NiCl₂, NiO, RuCl₃, RuOHCl₃, H₂PtCl₄, PtCl₂, PdCl₂.

Powder mixture of solid reagent and catalyst or mixture compressed as a tablet is loaded into the cartridge (2).

The device weight is reduced due to the fact that the produced hydrogen is supplied directly to the charged cylinder (no receiver); due to minimization of the reaction chamber volume and weight, weight of the reaction mixture, amount of water used and reactor volume, which are possible owing to complete reacting of the reaction mixture and reaction water; and also due to refusal from a compressor.

Maintaining the temperature and pressure inside the reactor below the maximum-permissible 250° C. and 700 bar is ensured due to water portion feeding and passive heat removal from the reactor surface owing to extended reactor surface, and also owing to use of cartridges with pre-dosed amount of solid reagent. The reaction chamber is designed to maintain high pressure (up to 400 bar) at 250° C.

Possibility of high-pressure charging is ensured due to the fact that hydrolysis reaction with the claimed solid reagents is irreversible and does not stop when pressure raises up to 700 bar and higher.

Elimination of power costs is ensured due to use of hand pump.

The claimed device provides with high-purity high-pressure hydrogen charging in any place, where liquid reagent is available and it is possible to deliver the claimed device, owing to possibility of delivering the claimed device disassembled to the cylinder hydrogen charging place, and also owing to use of liquid reagent supply means and cooling means in the cylinder hydrogen charging place.

The invention has been disclosed above with reference to a specific embodiment. Other embodiments of the disclosure will be apparent to those skilled in the art without departing from its substance, as it is disclosed in the present description. Accordingly, the invention should be considered limited in scope only by the following claims.

1. The self-contained portable device for filling cylinders with high-pressure hydrogen comprising a reaction chamber containing a solid reagent cartridge and reaction liquid pipe configured to supply liquid reagent to the lower part of the reaction chamber, a refrigerant dryer comprising installed in series a hydrogen cooler, filter-separator and hydrogen dryer, liquid reagent pipeline connected with the reaction liquid pipe, high-pressure hand pump connected with the liquid reagent pipeline to the reaction chamber and configured to feed liquid reagent in portions to the reaction chamber, gaseous hydrogen pipeline connecting the reaction chamber and refrigerant dryer, treated gaseous hydrogen pipeline configured to supply high-pressure hydrogen from the refrigerant dryer to a cylinder, wherein the gaseous hydrogen pipeline, treated gaseous hydrogen pipeline and liquid reagent pipeline are equipped with quick-release couplings, and the reaction chamber is placed in the reaction chamber cooling tank.
